(19) United States
(12) Patent Application Publication
(10) Pub. No.: US 2026/0141806 A1
(43) Pub. Date: May 21, 2026

(54) ROAD POTHOLE INFORMATION PROVIDING SYSTEM, ROAD POTHOLE INFORMATION PROVIDING METHOD THEREOF, AND VEHICLE FOR THE SAME

(71) Applicants: Hyundai Motor Company, Seoul (KR); Kia Corporation, Seoul (KR)

(72) Inventors: Jae Kyu Cho, Hwaseong (KR); Sang Seok Lee, Hwaseong-Si (KR); Hyun Mok Kim, Hwaseong-Si (KR)

(21) Appl. No.: 19/230,856

(22) Filed: Jun. 6, 2025

(30) Foreign Application Priority Data
Nov. 19, 2024 (KR) 10-2024-0165601

(51) Int. Cl. G08G 1/0967; G06V 20/56

(52) U.S. Cl. CPC G08G 1/096791; G06V 20/588

(57) ABSTRACT

The present disclosure relates to a road pothole information providing technique. A road pothole information providing system according to an embodiment of the present invention may comprise: a vehicle that primarily determines whether there is a pothole in a captured road image and provides the road image and pothole information when it is determined that there is a pothole; and a server that receives the road image and the pothole information provided by the vehicle, secondarily determines whether there is a pothole in the road image, and stores the pothole information when it is determined that there is a pothole.

### CROSS REFERENCE TO RELATED APPLICATION

The present application claims priority to Korean Patent Application No. 10-2024-0165601, filed Nov. 19, 2024, in the Korean Intellectual Property Office, the entire contents of which are incorporated by reference for all purposes.

### FIELD

The present disclosure is related to vehicle controls, and more specifically to detecting potholes.

### BACKGROUND

A pothole refers to a pot-shaped depression in a road surface. When a vehicle drives over a pothole, the vehicle's tires may receive a high impact momentarily, and this may cause internal damage to the tire. In addition, if the impact energy received by the tires as the vehicle passes over the pothole exceeds a certain level, it may lead to an automobile accident.

Although there are techniques that utilize impact detection sensors (e.g., accelerometers) to detect potholes, detecting potholes only by sensing the impact of driving over them may be limited in its accuracy.

### SUMMARY

One or more example embodiments of the present disclosure have been made to provide a road pothole information providing technique that can be applied to a vehicle (e.g., “connected car” or “connected vehicle”) implemented to provide various services based on communication with a server connected through a communication network.

Another object of the present disclosure is to provide a road pothole information providing technique, which can determine whether there is a pothole based on an image acquired by a vehicle passing through a road pothole in front of the vehicle and provide pothole location information to the vehicle that use the service.

Another object of the present disclosure is to provide a system and method for implementing the road pothole information providing technique proposed in the present disclosure.

Another object of the present disclosure is to provide a vehicle capable of implementing the road pothole information providing technique proposed in the present disclosure.

The technical problems addressed in the present disclosure are not limited to the problems mentioned above, and those skilled in the art may clearly understand other problems to be solved by the present disclosure from the following descriptions.

As a technical means for achieving the objects described above, a road pothole information providing technique can be provided.

A system may comprise: a first vehicle configured to: perform a primary determination of whether there is a pothole in a captured road image; and provide, based on the primary determination indicating that the pothole is in the captured road image, the captured road image and pothole information; and a server configured to: receive the captured road image and the pothole information provided by the first vehicle; perform a secondary determination of whether the pothole is in the captured road image; store, based on the secondary determination indicating that the pothole is in the captured road image, the pothole information; generate an indication of the pothole information associated with a location of the pothole corresponding to the pothole information; and transmit, to a plurality of vehicles, the indication.

The pothole information may indicate: a road that the first vehicle has entered, and the location of the pothole, and the server may be further configured to store an association between the road and the location.

The first vehicle may be configured to provide the captured road image and the pothole information by: determining a reliability value of the primary determination; and sending, based on the reliability value being greater than a threshold value, the captured road image and the pothole information to the server.

The system may further comprise a second vehicle configured to: send, to the server, a request for information regarding a road section of a road on which the second vehicle is traveling; and receive, from the server, pothole location information that is associated with the road section, wherein the pothole location information indicates the location of the pothole corresponding to the pothole information.

The second vehicle may comprise a navigation vision service processor configured to process an image of the road, wherein the navigation vision service processor is activated by the receiving of the pothole location information.

The second vehicle may be further configured to: determine, based on a location of the second vehicle and the pothole location information, a distance between the second vehicle and the pothole; and activate, based on the determined distance being within a threshold distance, a pothole detection operation to detect potholes.

The second vehicle may be further configured to, based on a road image that is captured after the pothole detection operation is activated, detect the pothole on the road.

The second vehicle may be further configured to output, based on detecting at least one pothole, a pothole warning.

A system may comprise: a vehicle configured to send a request for road hazard information on a road section; and a server configured to: in response to the request and based on determining that there is a pothole on the road section, provide, to the vehicle, pothole location information associated with the pothole, wherein the vehicle is further configured to: determine, based on the pothole location information and a location of the vehicle, a distance between the vehicle and the pothole; and output, based on the distance being within a threshold distance, a pothole warning.

The request may comprise road information of a road on which the vehicle is traveling, and wherein the server is further configured to provide, to the vehicle, the pothole location information that matches the road information.

A method performed by an apparatus of a vehicle may comprise: obtaining, via a camera, an image of a road; determining whether there is a pothole in the image of the road; sending, to a server based on a determination that the pothole is in the image, the image and pothole information; and causing the server to perform a secondary determination of whether the pothole is in the image, store, based on the secondary determination indicating that the pothole is in the image, the pothole information, and generate an indication of the pothole information associated with a location of the pothole corresponding to the pothole information.

The sending of the image and the pothole information may comprise: determining a reliability value of the determination that the pothole is in the image; and sending, based on the reliability value being greater than a threshold value, the image and the pothole information.

The method may further comprise: sending, to the server, a request for a location for activating a road pothole detection operation to detect potholes; and receiving, from the server, pothole location information associated with the road.

The method may further comprise: determining, based on vehicle location information and the pothole location information, a distance between the vehicle and the pothole; and activating, based on the determined distance being within a threshold distance, the road pothole detection operation.

The determining of whether there is a pothole may be performed based on an image captured after the activating of the road pothole detection operation.

The method may further comprise: after sending the pothole information, sending, to the server, a request to provide pothole location information based on the vehicle entering a new road; receiving, from the server, the pothole location information; determining, based on the pothole location information and vehicle location information, a distance between the vehicle and the pothole; and outputting, based on the determined distance being within a threshold distance, a pothole warning.

Specific matters according to various example embodiments of the present disclosure, other than the means for solving the problems mentioned above, are included in the descriptions and drawings.

According to the present disclosure, it is possible to provide a road pothole information providing technique that can be applied to a connected vehicle implemented to provide various services based on communication with a server connected through a communication network.

Furthermore, it is possible to provide a road pothole information providing technique, which can determine whether there is a pothole based on an image acquired by a vehicle passing through a road pothole in front of the vehicle and provide pothole location information to the vehicle that use the service.

When the road pothole information providing technique according to the present disclosure is applied to a vehicle, pothole location information may be provided to the vehicle, and the vehicle driver may know the location of potholes in advance based on the pothole location information and drive safely by taking into account the potholes.

Therefore, it is possible to deal with potholes more effectively and safely than dealing with the potholes based on the vehicle's own pothole detection technique, and prevent damage to tires and accidents caused by the damage.

In addition, even the vehicles that are not equipped with a pothole detection device of their own may also receive pothole guidance through the connected service and prevent accident in advance.

The effects of the example embodiments of the present disclosure are not limited to the effects mentioned above, and other unmentioned effects will be clearly understood by those skilled in the art from the following descriptions.

Since the problems to be solved, the means for solving the problems, and details of the effects mentioned above do not specify essential features of the claims, the scope of the rights of the claims is not limited by those described in the disclosure.

### BRIEF DESCRIPTION OF THE DRAWINGS

The drawings attached below are intended to help understanding of the one or more example embodiments of the present disclosure and provide. However, the technical features of the example embodiments are not limited to specific drawings, and the features shown in each drawing may be combined with features shown in any other drawing.

FIG. 1 is a view showing the configuration of a road pothole information providing system.

FIG. 2 is a view for explaining a process of providing a vehicle with road pothole information by a server.

FIG. 3 is a view for explaining a process of activating a road pothole detection function of a vehicle by a server.

FIG. 4 is a view for explaining a process of outputting a pothole warning by a vehicle.

FIG. 5 shows an example computing system.

### DETAILED DESCRIPTION

The advantages and features of the present disclosure, and the method for achieving the same, will become clear with reference to one or more example embodiments described below in detail together with the accompanying drawings. However, the present disclosure is not limited to the example embodiments disclosed herein, and may be implemented in various different forms, and these example embodiments are provided to inform those skilled in the art of the scope of the disclosure.

Since the shapes, sizes, ratios, angles, numbers, and the like disclosed in the drawings for explaining the embodiments of the present disclosure are examples, the present disclosure is not limited to the illustrated matters. Like reference numerals refer to like elements throughout the specification. In addition, when it is determined in describing the present disclosure that a detailed description of a related known technique may unnecessarily obscure the gist of the present disclosure, the detailed description will be omitted. When terms such as “include”, “have”, “configured of”, and the like are used in this specification, other parts may be added as far as “only” is not used. When a component is expressed in a singular form, it includes a case including plural forms unless specially stated otherwise.

In interpreting a component, it is interpreted as including an error range although explicit description of the error range is not provided separately.

In the case of describing a time relation, when a temporal precedence as “after”, “subsequently”, “next to”, “before”, or the like is described, it may also include cases where it is not continuous as long as “immediately” or “directly” is not used.

Although terms such as first, second, and the like are used to describe various components, these components are not limited by these terms. These terms are used only to distinguish one component from another. Accordingly, a first component referred to hereinafter may also be a second component within the technical spirit of the present disclosure.

In describing components of the present disclosure, terms such as first, second, A, B, (a), (b), and the like may be used. These terms are intended only to distinguish the components from the other components, and the nature, order, sequence, or number of the components are not limited by the terms. It should be understood that when a component is described as being “linked”, “coupled”, or “connected” to another component, the component may be directly linked or connected to another component, but other components may also be “interposed” between indirectly linked or connected components that do not specially have explicit description.

“At least one” should be understood as including one or more combinations of associated components. For example, “at least one among first, second, and third components” may be understood to include any combination of two or more of the first, second, and third components, as well as the first, second, or third components.

Individual features of various example embodiments of this specification may be partially or wholly coupled or combined with each other, and various interconnections and operations thereof are possible technically, and the example embodiments may be implemented to be independent from each other or implemented together in an associative relationship.

The scale of the components shown in the drawings is different from the actual scale for convenience of explanation, and it is not limited to the scale shown in the drawings.

At least in some implementations, vehicles may provide various services based on communication with a server connected through a communication network. Such vehicles are also referred to as “connected vehicles.”

When pothole information is provided to connected vehicles in advance, safer driving can be achieved in terms of navigating around potholes and other hazards. Therefore, various studies are required to provide services that allow safe driving in relation to potholes on the road.

Hereinafter, a road pothole information providing system, a road pothole information providing method thereof, and a vehicle for the same will be described with reference to the accompanying drawings.

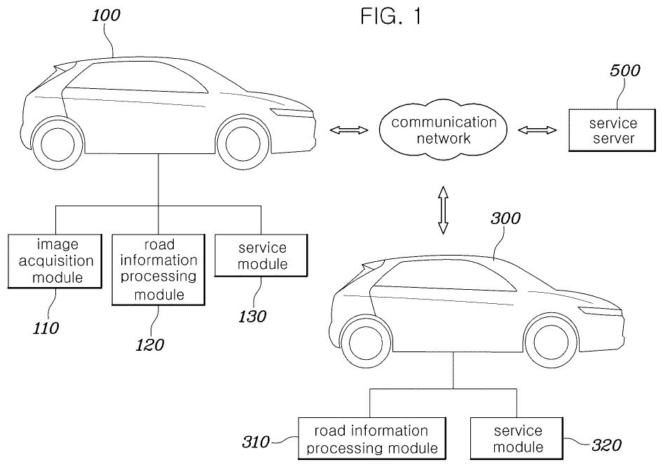

FIG. 1 is a view showing the configuration of a road pothole information providing system.

Referring to FIG. 1, a road pothole information providing system may be configured to include a first vehicle 100, a second vehicle 300, and a server (also referred to as a service server) 500, and the configuration of the road pothole information providing system is not limited thereto.

For example, the road pothole information providing system may include a communication base station installed on the road to form a communication network between the vehicles 100 and 300 and the server 500. For example, the communication base station may be a roadside base station or a mobile communication base station, but it is not limited thereto. For example, the communication base station may perform communication between the vehicles 100 and 300 and the server 500 within a predetermined road link (e.g., an intersection, a road section, a road ID, etc.). For example, a road link refers to a section of a road between two points (nodes) and is used in map data or traffic systems to identify and represent individual segments of a roadway.

The first vehicle 100 may be implemented to provide a pothole image to the server 500 and receive road pothole location information provided by the server 500.

The first vehicle 100 may be a vehicle that provides a pothole image captured when passing through a road pothole to the server 500 and receives road pothole location information from the server 500, and the second vehicle 300 may be a vehicle implemented to receive road pothole location information provided by the server 500 although it does not provide a pothole image to the server 500.

The first vehicle 100 may include an image acquisition module (e.g., a camera, an image sensor) 110, a road information processing module (e.g., a processor) 120, and a service module 130.

The image acquisition module 110 may acquire a road image by photographing the driving front side of the first vehicle 100. For example, the image acquisition module 110 may be implemented as a built-in camcorder or a camera for a surround view monitoring (SVM) system mounted on the first vehicle 100. For example, the image acquisition module 110 may be implemented as a camera dedicated to the road pothole information provision system.

The image acquisition module 110 may store the acquired road image and provide it to the road information processing module 120. For example, the image acquisition module 110 may provide the road image to the road information processing module 120 in response to a request from the road information processing module 120.

The road information processing module 120 processes the road image provided by the image acquisition module 110 to determine whether there is a pothole, and may provide the road image, a result of determining whether there is a pothole in the road image, reliability of the determination result, information on the location of the pothole, and the like to the service module 130.

For example, the road information processing module 120 may be a navigation vision service module (also referred to as a navigation vision service processor) capable of providing a navigation vision service. The navigation vision service module may include, for example, a processor and a camera. For example, the road information processing module 120 may be a navigation system previously mounted on the vehicle, but it is not limited thereto. For example, when the road information processing module 120 is a navigation system, the road information processing module 120 may be activated by an external control signal, rather than in real time, and request and receive a road image from the image acquisition module 110 in consideration of the system load of the navigation system.

If the road information processing module 120 receives a pothole detection activation signal from the service module 130, it may request and receive a road image from the image acquisition module 110.

The road information processing module 120 may provide location information of the first vehicle 100 to the service module 130.

If the first vehicle 100 enters a new road link (e.g., a new intersection, a new road section, etc.), the road information processing module 120 may provide new road link entry information to the service module 130.

If the road information processing module 120 receives a pothole warning signal and road pothole location information from the service module 130, it may activate a pothole warning service to display the road pothole location and output a warning.

The service module 130 may communicate with the outside so that the first vehicle 100 may perform its function as a “connected car” and may be named as a “connected car service (CCS) module.”

The service module 130 may be linked to the server 500. For example, the service module 130 may be linked to the server 500 through a communication base station in charge of the road link to which the first vehicle 100 belongs.

The service module 130 may provide the information provided by the road information processing module 120 to the server 500.

The service module 130 may receive a road image, a result of determining whether there is a pothole in the road image, reliability of the determination result, and information on the location of the pothole from the road information processing module 120.

For example, when reliability of the determination result is higher than a preset reference reliability, the service module 130 may provide the road image and the pothole location information to the server 500.

In this way, when the service module 130 provides the road image and the pothole location information to the server 500 in the case where the reliability of the determination result is higher than a preset reference reliability, reliability of the road pothole location information provided by the server 500 may be enhanced.

The service module 130 may receive the road pothole location information provided by the server 500.

For example, based on the first vehicle 100 entering a new road link (e.g., before, when, and/or after entering or determining the new road), the service module 130 may request the server 500 to provide road information (e.g., road hazard information) related to the road link where the first vehicle 100 has newly entered. Specifically, the service module 130 may request the server 500 to provide the location of activating a road pothole detection function related to the road link where the first vehicle 100 has newly entered.

The service module 130 may provide road link (e.g., road, road section, intersection, etc.) information if the location of activating the road pothole detection function is requested. For example, the service module 130 may provide the server 500 with a message that requests the location of activating the road pothole detection function including the road link information.

The service module 130 may receive information on the location of a pothole related to the road link where the first vehicle 100 has entered from the server 500 in response to a request for road information (e.g., the request for the location for activating the road pothole detection function).

When the first vehicle 100 approaches the location of a pothole, the service module 130 may output a pothole warning signal and road pothole location information to the road information processing module 120 based on the pothole location information provided by the server 500 and the location information of the first vehicle 100 provided by the road information processing module 120.

When the first vehicle 100 approaches the location of a pothole, the service module 130 may output a pothole detection activation signal to the road information processing module 120 so that the road information processing module 120 may perform pothole detection based on the road image.

For example, when the location of the first vehicle 100 and the location of the pothole are within a preset threshold distance, the service module 130 may output a pothole warning signal and road pothole location information to the road information processing module 120.

Here, the threshold distance may be set through experiments performed based on various road environments, and may be set considering the current speed of the vehicle. For example, the threshold distance in the case where the current speed of the vehicle is high may be set to be larger than the threshold distance in the case where the current speed of the vehicle is relatively low. For example, the threshold distance may be set considering the time required for the vehicle to move to the pothole location.

The second vehicle 300 does not provide a road image to the server 500, and may receive pothole location information provided by the server 500.

The second vehicle 300 may include a road information processing module 310 and a service module 320.

The road information processing module 310 may provide location information of the second vehicle 300 to the service module 320. For example, the road information processing module 310 may be a navigation system previously mounted on the second vehicle 300, but it is not limited thereto.

If the road information processing module 310 receives a pothole warning signal and pothole location information from the service module 320, it may activate a pothole warning service to display the pothole location and output a warning.

The service module 320 may communicate with the outside so that the second vehicle 300 may perform its function as a “connected car” and may be named as a “connected car service (CCS) module.”

The service module 320 may be linked to the server 500. For example, the service module 320 may be linked to the server 500 through a communication base station in charge of the road link to which the second vehicle 300 belongs.

The service module 320 may receive the pothole location information provided by the server 500.

When the second vehicle 300 enters a new road link, the service module 320 may request the server 500 to provide road pothole location information related to the road link where the second vehicle 300 has newly entered.

When the second vehicle 300 approaches the location of a road pothole, the service module 320 may output a pothole warning signal and road pothole location information to the road information processing module 310 based on the road pothole location information provided by the server 500 and the location information of the second vehicle 300 provided by the road information processing module 310.

In this way, the second vehicle 300 may receive information related to road potholes although it is not equipped with an image acquisition module, such as an expensive built-in camcorder that captures images by photographing the front side of the vehicle.

The road information processing module 310 mounted on the second vehicle 300 displays road pothole locations and performs a pothole warning function of outputting a warning according to the pothole warning signal and the road pothole location information provided by the service module 320.

Accordingly, the road information processing module 310 does not perform a function of determining whether there is a pothole by processing a road image, a function of determining reliability of a determination result, and the like. Accordingly, even when the road information processing module 310 is a navigation system, there may be a room for resource management.

The server 500 may receive road images and pothole location information provided by the vehicle. In addition, the server 500 may receive road link information from the vehicle.

An example in which the server 500 receives road images and pothole location information from the first vehicle 100 is described.

The server 500 may process a road image provided by the first vehicle 100 and determine whether there is a pothole in the road image.

When the server 500 determines that there is a pothole in the road image, it may store road link information and pothole location information to match each other (e.g., store an association between the road and the location of the pothole).

Since the server 500 may allocate more resources to process the road image compared with the road information processing module 120 installed in the first vehicle 100, it may determine whether there is a pothole in the road image more accurately.

Accordingly, reliability of determining whether there is a pothole in the road image can be further increased as the server 500 determines again whether there is a pothole in the road image, which is determined by the first vehicle 100 that there is a pothole.

The server 500 may activate the road pothole detection function of the first vehicle 100 (e.g., activate a processor for detecting potholes) so that the first vehicle 100 may detect road potholes.

If the server 500 receives a request for the location of activating the road pothole detection function from the first vehicle 100, it may provide pothole location information to the first vehicle 100.

For example, the server 500 may receive road link information, together with a request for the location of activating the road pothole detection function, from the first vehicle 100, and provide the first vehicle 100 with pothole location information related to the road link.

To this end, the server 500 may store pothole monitoring activation road link information and pothole location information to match each other (e.g., store an association between the road and the location of the pothole).

The server 500 may output a warning guidance request to the vehicle.

An example in which the server 500 outputs a pothole warning guidance request to the second vehicle 300 is described.

If the server 500 receives a request for road pothole location information from the second vehicle 300, it may output a pothole warning guidance request including pothole location information to the second vehicle 300.

For example, the server 500 may receive road link information together with a request for road pothole location information, and output pothole location information that matches the road link.

For example, the first vehicle 100, the second vehicle 300, and the server 500 may include at least one processor, at least one memory, and at least one communication module.

For example, a processor may be a data processing device implemented in hardware having a circuit of a physical structure for executing desired operations. For example, the desired operations may include code or instructions included in a program.

For example, the data processing device implemented in hardware may include a microprocessor, a central processing unit, a processor core, a multi-core processor, a multiprocessor, an application-specific integrated circuit (ASIC), and a field programmable gate array (FPGA).

For example, the memory may be implemented as at least one or more storage media (recording media) among storage media such as a flash memory, a hard disk, a Secure Digital Card (SD card), a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a removable disk, and a web storage.

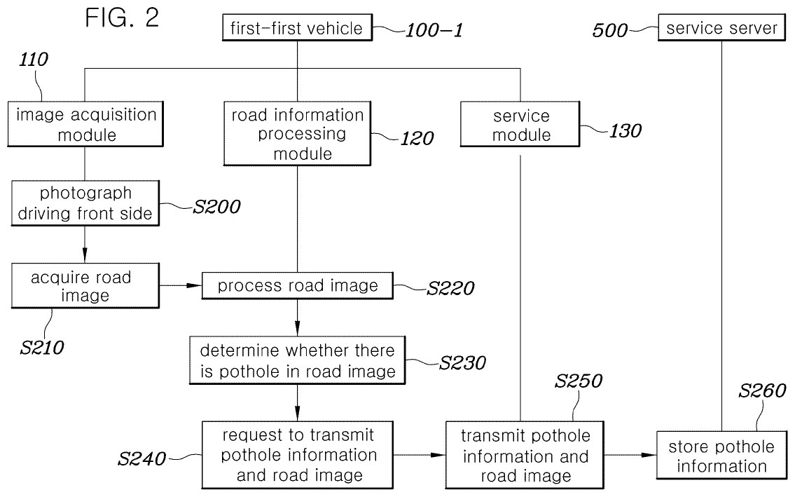

FIG. 2 is a view for explaining a process of providing a vehicle with road pothole information by a server.

A process of providing a vehicle with road pothole information by a server is described with reference to FIG. 2, and a process of providing road pothole information to the server 500 by the first vehicle 100 of FIG. 1 is described as an example.

To clarify that the first vehicle 100 is a vehicle that acquires road images on its own without request from the server 500, it is denoted as a first-first vehicle 100-1.

The image acquisition module 110 may photograph the driving front side of the first-first vehicle 100-1 (S200) and acquire and store a road image through the photographing (S210).

Thereafter, the road information processing module 120 may process the road image acquired by the image acquisition module 110 (S220) and determine whether there is a pothole in the road image (S230).

At step S220, when the road information processing module 120 receives a pothole detection activation signal from the service module 130, it may request and receive a road image from the image acquisition module 110 and process the received road image.

After processing the road image and determining whether there is a pothole, the road information processing module 120 may request the service module 130 to transmit pothole information and the road image (S240).

Here, the pothole information may include a result of determining whether there is a pothole in the road image, reliability of the determination result, information on the pothole location, and the like.

In addition, the road information processing module 120 may provide location information of the first-first vehicle 100-1 to the service module 130.

The service module 130 may transmit the pothole information and road image to the server 500 in response to the request of the road information processing module 120 (S250).

At step s250, when reliability is higher than a preset reference reliability as a result of the determination, the service module 130 may transmit the pothole information and road image to the server 500.

For example, the pothole information transmitted from the service module 130 to the server 500 may include road link information and pothole location information.

The service module 130 may transmit the pothole information and road image to the service server 500 through a communication base station in charge of communication related to the road link where the first-first vehicle 100-1 has entered.

When the server 500 receives the pothole information and road image from the service module 130, it may store the pothole information (S260).

The server 500 may process the road image and determine whether there is a pothole in the road image, and store pothole information when it determines that there is a pothole in the road image.

The server 500 may store road link information and pothole location information to match each other.

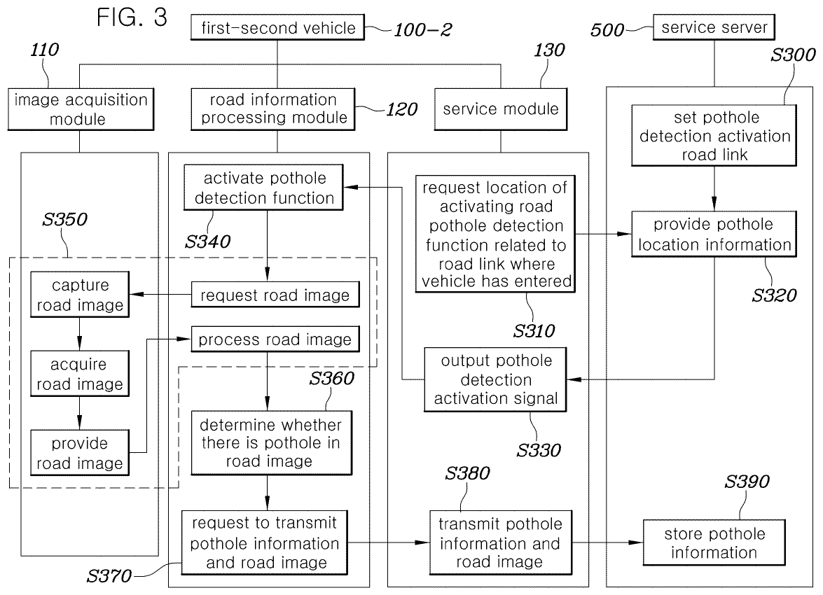

FIG. 3 is a view for explaining a process of activating a road pothole detection function of a vehicle by a server.

For example, a vehicle may perform a process of providing road pothole information described in FIG. 2 after being activated according to FIG. 3.

A process of activating a road pothole detection function of a vehicle by the server 500 is described with reference to FIG. 3, and a process of activating the road pothole detection function of the first vehicle 100 of FIG. 1 by the server 500 is described as an example.

To clarify that the first vehicle 100 is a vehicle that acquires road images in response to request from the server 500, it is denoted as a first-second vehicle 100-2.

First, the server 500 may set a pothole detection activation road link (S300). For example, setting the pothole detection activation road link may be performed based on the standard node link database provided by the National Traffic Information Center.

For example, setting at step s300 does not have to be performed in the process of activating the road pothole detection function, and may be omitted from the process of activating the road pothole detection function. For example, setting at step s300 may be performed at the time when the road pothole information providing system is constructed.

When the first-second vehicle 100-2 enters a new road link, the service module 130 may request the server 500 to provide the location of activating the road pothole detection function (S310).

The server 500 may provide the service module 130 with the pothole location information related to the road link in response to the request of the service module 130 (S320).

When the first-second vehicle 100-2 approaches the location of a pothole based on the location information of the first-second vehicle 100-2 and the pothole location information, the service module 130 may output a pothole detection activation signal to the road information processing module 120 (S330).

The road information processing module 120 may activate the pothole detection function in response to the pothole detection activation signal (S340).

After being activated, the road information processing module 120 may request the image acquisition module 110 to provide a road image, and process the road image provided by the image acquisition module 110 (S350).

For example, the image acquisition module 110 may acquire a road image by capturing the road image in front of the first-second vehicle 100-2, and provide the acquired image to the road information processing module 120.

Thereafter, steps S230 to S260 in FIG. 2 may be performed.

Describing again briefly, the road information processing module 120 may determine whether there is a pothole in the road image based on processing the road image (S360).

After determining whether there is a pothole, the road information processing module 120 may request the service module 130 to transmit the pothole information and road image (S370).

The service module 130 may transmit the pothole information and road image to the server 500 in response to the request of the road information processing module 120 (S380).

When the server 500 receives the pothole information and road image from the service module 130, it may store the pothole information (S390).

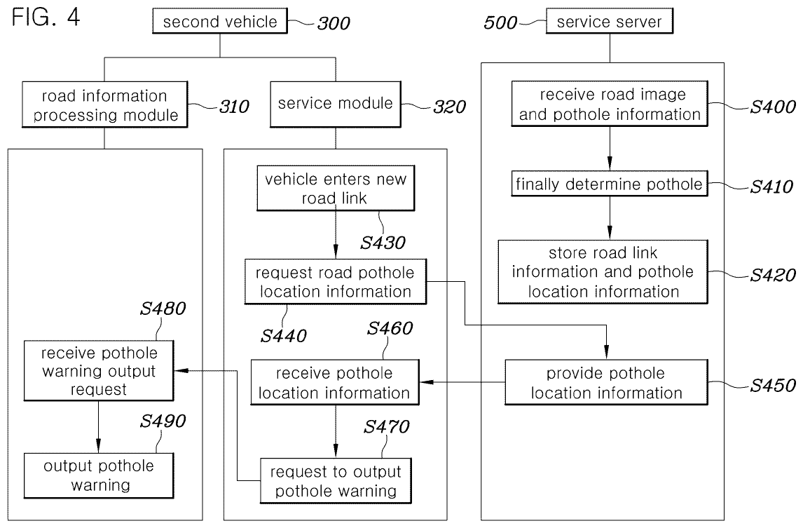

FIG. 4 is a view for explaining a process of outputting a pothole warning by a vehicle.

A process of outputting a pothole warning by a vehicle is described with reference to FIG. 4, and a process of outputting a pothole warning by the second vehicle 300 of FIG. 1 is described as an example.

First, the server 500 may receive the road image and pothole information provided by the first vehicle 100 (S400). Here, the pothole information may include road link information and pothole location information.

The server 500 may finally determine whether there is a pothole by processing the road image (S410), and store road link information and pothole location information to match each other (S420).

When the second vehicle 300 enters a new road link (S430), the service module 320 may request the server 500 to provide road pothole location information (S440).

At step s440, when the road pothole location information is requested, the server 500 may provide the road link information together.

The server 500 may provide pothole location information that matches the road link to the service module 320 in response to the request of the service module 320 (S450).

Accordingly, the service module 320 may receive the pothole location information provided by the server 500 (S460).

Thereafter, when the second vehicle 300 approaches the location of a pothole, the service module 320 may request the road information processing module 310 to output a pothole warning based on the pothole location information provided by the server 500 and the location information of the second vehicle 300 provided by the road information processing module 310 (S470).

At step s470, the service module 320 may determine the distance between the second vehicle 300 and the pothole based on the pothole location information and the location information of the second vehicle 300, and when the determined distance falls within a preset threshold distance, it may request the road information processing module 310 to output a pothole warning.

At step s470, the service module 320 may output a pothole warning signal and road pothole location information to the road information processing module 310.

The road information processing module 310 may receive a pothole warning output request from the service module 320 (S480), and display the location of the pothole and output a warning in response to the pothole warning output request (S490).

Although it has been described above that the first vehicle 100 provides pothole information to the server 500, like the second vehicle 300, the first vehicle 100 may output a pothole warning based on the pothole information provided to the server 500.

For example, the first vehicle 100 may be set as at least one among an information providing vehicle and an information receiving vehicle. For example, the first vehicle 100 may be set as an information providing vehicle and provide information on the road potholes to the server 500 according to the process illustrated in FIG. 2 or FIG. 3. For example, the first vehicle 100 may be set as an information receiving vehicle and receive information on the road potholes from the server 500 according to the process illustrated in FIG. 4. For example, the first vehicle 100 may be set as an information providing vehicle and an information receiving vehicle and provide information on the road potholes to the server 500 and receive information on the road potholes from the server 500.

The second vehicle 300 is an information receiving vehicle that may not provide information on the road potholes to the server 500 and only receive information on the road potholes from the server 500.

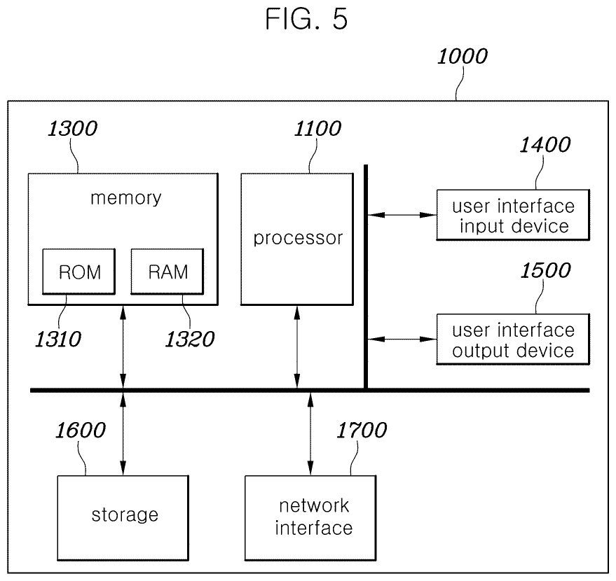

FIG. 5 shows an example computing system (e.g., a computing device of a vehicle or any other apparatus). One or more controllers, processors, etc. described herein may be implemented by the computing system or may be implemented in the computing system.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A road pothole information providing technique may comprise: a first vehicle that primarily determines whether there is a pothole in a captured road image and provides the road image and pothole information when it is determined that there is a pothole; and a service server that receives the road image and the pothole information provided by the first vehicle, secondarily determines whether there is a pothole in the road image, and stores the pothole information when it is determined that there is a pothole.

The pothole information may include road link information where the first vehicle has entered and pothole location information, and the server may store the road link information and the pothole location information to match each other.

The first vehicle may further determine reliability of a result of determining whether there is a pothole, and provide the road image and the pothole information to the service server when the reliability is higher than a preset reference reliability.

The road pothole information providing system may further comprise a second vehicle that requests the service server to provide road information when entering a new road link, and receives pothole location information that matches the new road link from the service server in response to the road information request.

The second vehicle may include a navigation vision service module that analyzes the road image, and the navigation vision service module may be activated by reception of the pothole location information.

The second vehicle may determine a distance between the vehicle and the pothole based on vehicle location information and the pothole location information, and activate a road pothole detection function when the determined distance is within a preset threshold distance.

The second vehicle may determine whether there is a pothole based on the road image captured after the road pothole detection function is activated.

The second vehicle may further perform a pothole warning function when the determined distance is within the preset threshold distance.

A road pothole information providing system may comprise: a vehicle that requests road information on a newly entered road link; and a service server that provides pothole location information to the vehicle when there is a pothole on the road link in response to a road information request of the vehicle, wherein the vehicle may determine a distance between the vehicle and the pothole based on the pothole location information and vehicle location information, and perform a pothole warning function when the determined distance is within a preset threshold distance.

The vehicle may request the service server to provide the pothole location information when the vehicle enters a new road link, and provide road link information when requested, wherein the service server may provide the pothole location information that matches the road link information to the vehicle.

A road pothole information providing method may comprise the steps of: primarily determining whether there is a pothole in a captured road image, by a vehicle; providing the road image and pothole information to a service server when it is determined there is a pothole, by the vehicle; receiving the road image and the pothole information, and secondarily determining whether there is a pothole in the road image, by the service server; and storing the pothole information when it is determines that there is a pothole, by the service server.

The step of providing the road image and pothole information to a service server may include further determining reliability of a result of determining whether there is a pothole, and providing the road image and the pothole information to the service server when the reliability is higher than a preset reference reliability, by the vehicle.

The road pothole information providing method may further comprise the steps of: before the step of primarily determining whether there is a pothole in a captured road image, by a vehicle, entering a new road link, and requesting the service server to provide a location of activating a road pothole detection function, by the vehicle; and receiving pothole location information that matches the new road link from the service server, by the vehicle.

The road pothole information providing method may further comprise the steps of: determining a distance between the vehicle and the pothole based on vehicle location information and the pothole location information, by the vehicle; and activating the road pothole detection function when the determined distance is within a preset threshold distance, by the vehicle.

The step of primarily determining whether there is a pothole may be performed based on the road image captured after the road pothole detection function is activated, by the vehicle.

The road pothole information providing method may further comprise the steps of: after the step of storing the pothole information, requesting the service server to provide pothole location information when the vehicle enters a new road link, and receiving the pothole location information from the service server, by the vehicle; determining a distance between the vehicle and the pothole based on the pothole location information and vehicle location information, by the vehicle; and performing a pothole warning function when the determined distance is within a preset threshold distance, by the vehicle.

A vehicle may be set as at least one among an information providing vehicle and an information receiving vehicle, and when the vehicle is set as the information providing vehicle, the vehicle may determine whether there is a pothole in a captured road image, and provide the road image and pothole information to the service server when it is determined that there is a pothole.

The vehicle may further determine reliability of a result of determining whether there is a pothole, and provide the road image and the pothole information to the service server when the reliability is higher than a preset reference reliability.

When the vehicle is set as the information receiving vehicle, the vehicle may request the service server to provide road information when entering a new road link, determine a distance between the vehicle and the pothole based on pothole location information and vehicle location information provided by the service server in response to the road information request, and perform a pothole warning function when the determined distance falls within a preset threshold distance.

When the vehicle is set as the information providing vehicle and the information receiving vehicle, the vehicle may determine whether there is a pothole in a captured road image, and provide the road image and pothole information to the service server when it is determined that there is a pothole, and on the other hand, the vehicle may request the service server to provide road information when entering a new road link, determine a distance between the vehicle and the pothole based on pothole location information and vehicle location information provided by the service server in response to the road information request, and perform a pothole warning function when the determined distance falls within a preset threshold distance.

According to the present disclosure, there is provided a road pothole information providing technique that can be applied to a connected vehicle implemented to provide various services based on communication with a server connected through a communication network.

Furthermore, it is possible to provide a road pothole information providing technique that can predict pothole locations based on an image acquired by a vehicle passing through road potholes and provide pothole location information to the vehicle that use the service.

If the road pothole information providing technique according to the present disclosure is applied to a vehicle, pothole location information is provided to the vehicle, and the vehicle driver may know the location of potholes in advance based on the pothole location information and drive safely by taking into account the potholes.

Therefore, it is possible to deal with potholes more effectively and safely than dealing with the potholes based on the vehicle's own pothole detection technique, and prevent damage to tires and accidents caused by the damage.

Although the example embodiments of the present disclosure have been described in more detail with reference to the accompanying drawings, the present disclosure is not necessarily limited to these example embodiments, and various modifications can be made without departing from the technical spirit of the present disclosure. Accordingly, the example embodiments disclosed in this specification are intended not to limit but to explain the technical spirit of the present disclosure, and the scope of the technical spirit of the present disclosure is not limited by these example embodiments. Therefore, it should be understood that the example embodiments described above are exemplary in all aspects and not restrictive. The protection scope of the present disclosure should be interpreted by the claims, and all technical spirits within a scope equivalent thereto should be interpreted as being included in the scope of the right of the present disclosure.

What is claimed is:

1. A system comprising:
a first vehicle configured to:
perform a primary determination of whether there is a pothole in a captured road image; and
provide, based on the primary determination indicating that the pothole is in the captured road image, the captured road image and pothole information; and
a server configured to:
receive the captured road image and the pothole information provided by the first vehicle;
perform a secondary determination of whether the pothole is in the captured road image;
store, based on the secondary determination indicating that the pothole is in the captured road image, the pothole information;
generate an indication of the pothole information associated with a location of the pothole corresponding to the pothole information; and
transmit, to a plurality of vehicles, the indication.

2. The system of claim 1, wherein the pothole information indicates:
a road that the first vehicle has entered, and
the location of the pothole, and
wherein the server is further configured to store an association between the road and the location.

3. The system of claim 1, wherein the first vehicle is configured to provide the captured road image and the pothole information by:
determining a reliability value of the primary determination; and
sending, based on the reliability value being greater than a threshold value, the captured road image and the pothole information to the server.

4. The system of claim 1, further comprising a second vehicle configured to:
send, to the server, a request for information regarding a road section of a road on which the second vehicle is traveling; and
receive, from the server, pothole location information that is associated with the road section, wherein the pothole location information indicates the location of the pothole corresponding to the pothole information.

5. The system of claim 4, wherein the second vehicle comprises a navigation vision service processor configured to process an image of the road captured by a camera, wherein the navigation vision service processor is activated by the receiving of the pothole location information.

6. The system of claim 4, wherein the second vehicle is further configured to:
determine, based on a location of the second vehicle and the pothole location information, a distance between the second vehicle and the pothole; and
activate, based on the determined distance is being within a threshold distance, a pothole detection operation to detect potholes.

7. The system of claim 6, wherein the second vehicle is further configured to, based on a road image that is captured after the pothole detection operation is activated, detect the pothole on the road.

8. The system of claim 6, wherein the second vehicle is further configured to output, based on detecting at least one pothole, a pothole warning.

9. A system comprising:
a vehicle configured to send a request for road hazard information on a road section; and
a server configured to:
in response to the request and based on determining that there is a pothole on the road section, provide, to the vehicle, pothole location information associated with the pothole,
wherein the vehicle is further configured to:
determine, based on the pothole location information and a location of the vehicle, a distance between the vehicle and the pothole; and
output, based on the distance being within a threshold distance, a pothole warning.

10. The system of claim 9, wherein the request comprises road information of a road on which the vehicle is traveling, and wherein the server is further configured to provide, to the vehicle, the pothole location information that matches the road information.

11. A method performed by an apparatus of a vehicle, the method comprising:
obtaining, via a camera, an image of a road;
determining whether there is a pothole in the image of the road;
sending, to a server based on a determination that the pothole is in the image, the image and pothole information; and
causing the server to perform a secondary determination of whether the pothole is in the image, store, based on the secondary determination indicating that the pothole is in the image, the pothole information, and generate an indication of the pothole information associated with a location of the pothole corresponding to the pothole information.

12. The method of claim 11, wherein the sending of the image and the pothole information comprises:
determining a reliability value of the determination that the pothole is in the image; and
sending, based on the reliability value being greater than a threshold value, the image and the pothole information.

13. The method of claim 11, further comprising:
sending, to the server, a request for a location for activating a road pothole detection operation to detect potholes; and
receiving, from the server, pothole location information associated with the road.

14. The method of claim 13, further comprising:
determining, based on vehicle location information and the pothole location information, a distance between the vehicle and the pothole; and
activating, based on the determined distance being within a threshold distance, the road pothole detection operation.

15. The method of claim 14, wherein the determining of whether there is a pothole is performed based on an image captured after the activating of the road pothole detection operation.

16. The method of claim 11, further comprising:
after sending the pothole information, sending, to the server, a request to provide pothole location information based on the vehicle entering a new road;
receiving, from the server, the pothole location information;
determining, based on the pothole location information and vehicle location information, a distance between the vehicle and the pothole; and
outputting, based on the determined distance being within a threshold distance, a pothole warning.
